(19) United States
(12) Patent Application Publication
(10) Pub. No.: US 2008/0190978 A1
(43) Pub. Date: Aug. 14, 2008

(54) Mounting apparatus

(76) Inventor: Paul Brassard, Arcadia, CA (US)

Correspondence Address: JAMES E. BRUNTON, ESQ., P. O. BOX 29000, GLENDALE, CA, 91209, US

(21) Appl. No.: 11/707,455

(22) Filed: Feb. 14, 2007

(51) Int. Cl. B60R 11/02

(52) U.S. Cl. 224/483

(57) ABSTRACT

A mounting structure for mounting objects, such as electronic components of various types within a vehicle. The mounting structure includes a connector tongue that is adapted to be slidably received within a conventional compact disk drive access slot and a novel mounting assembly that is connected to the connector tongue. The mounting assembly includes a uniquely designed mounting plate to which various types of electronic components can be removably interconnected. The mounting plate is provided with one or more uniquely shaped connector elements that can be securely mated with an object connector plate to which the object to be mounted is connected.

### BACKGROUND OF THE INVENTION

### Field of the Invention

The present invention relates generally to mounting devices for supporting articles such as cell phones, powered Personal Digital Assistants (PDA's), satellite radios, Global Positioning Satellite (GPS) devices and like components within a vehicle. More particularly, the invention concerns an improved mounting structure which comprises a connector tongue that is adapted to be slidably received within a conventional compact disk drive access slot and a novel mounting assembly that is connected to the connector tongue and to which various types of articles can be removably interconnected.

### SUMMARY OF THE INVENTION

It is an object of the present invention to provide an improved mounting structure for mounting objects, such as electronic components of various types within a vehicle. More particularly it is an object of the invention to provide such a mounting structure that includes a connector tongue that is adapted to be slidably received within a conventional compact disk drive access slot and a novel mounting assembly that is connected to the connector tongue and includes a uniquely designed mounting plate to which various types of electronic components can be removably interconnected.

Another object of the invention is to provide an improved mounting structure of the aforementioned character in which the mounting plate is provided with one or more uniquely shaped connector elements that can be securely mated with an object connector plate to which the object to be mounted is connected.

Another object of the invention is to provide a mounting structure of the character described in the preceding paragraphs in which the combination of the mounting plate and the object connector plate can be swiveled relative to the connector tongue.

Another object of the invention is to provide a mounting structure of the class described in which the mounting plate provides a means for reliable, robust interconnection with the object connector plate.

Another object of the invention is to provide a mounting structure of the character described in which the mounting plate is provided with connector elements that are uniquely configured to minimize play between the object connector plate and the mounting plate.

Another object of the invention is to provide a mounting structure as described in the preceding paragraphs which is easy to use and is economical to manufacture in large quantities.

### BRIEF DESCRIPTION OF THE DRAWINGS

FIG. 1 is a generally perspective view of one form of the mounting structure of the invention for supporting an object within a vehicle having a compact disk player.

FIG. 2 is a generally perspective, illustrative view of the mounting structure of the invention shown in FIG. 1 in position to be interconnected with the compact disc player.

FIG. 3 is a side elevational view of the mounting structure illustrated in FIG. 1.

FIG. 4 is a top plan view of the mounting structure shown in FIG. 1 partly broken away to show one of the connector members of the device.

FIG. 4A is a bottom view of the mounting structure shown in FIG. 1.

FIG. 5 is a generally perspective, exploded view of the mounting structure illustrated in FIG. 1.

FIG. 6A is a generally perspective, exploded view of one form of the mounting plate and object connector plate of the invention, the mounting plate being partly broken away to better show the configuration of the connector elements of the device.

FIG. 6B is an exploded, side elevational view of one form of the mounting plate and object connector plate of the invention, the object connector plate being partially broken away to show internal construction.

FIG. 6C is a generally perspective view of the mounting plate and object connector plate of FIG. 6A as they appear when in the position to be moved into an interlocking configuration.

FIG. 6D is a cross-sectional view taken along lines 6D-6D of FIG. 6C.

FIG. 6E is a generally perspective, diagrammatic view, similar to FIG. 6C illustrating movement of the mounting plate and connector plate into an interlocking configuration.

FIG. 6F is a cross-sectional view taken along lines 6F-6F of FIG. 6E showing the mounting plate and connector plate in an interconnected configuration.

FIG. 7 is a generally perspective view of an alternate form of the mounting structure of the invention for supporting an object within a vehicle having a compact disk player.

FIG. 8 is a side elevational view of the mounting structure illustrated in FIG. 7.

FIG. 8A is a generally perspective, exploded view of the form of the mounting plate and object connector plate of the invention shown in FIGS. 7 and 8, the mounting plate being partly broken away to better show the configuration of the connector element of this latest form of the device.

FIG. 8B is an exploded, side elevational view of this alternate form of the mounting plate and object connector plate of the invention, the object connector plate being partially broken away to showing internal construction.

FIG. 8C is a generally perspective view of the mounting plate and object connector plate of FIG. 8A as they appear when in the position to be moved into an interlocking configuration.

FIG. 8D is a view similar to FIG. 8B showing the mounting plate and object connector plate as they appear when in position to be moved into an interlocking configuration.

FIG. 8E is a generally perspective, diagrammatic view, similar to FIG. 8C illustrating movement of the mounting plate and connector plate into an interlocking configuration.

FIG. 8F is a view similar to FIG. 8D illustrating movement of the mounting plate and connector plate into an interlocking configuration.

FIG. 9 is a generally perspective, exploded view of still another form of the mounting structure of the invention for supporting an object within a vehicle having a compact disk player.

FIG. 10 is a side elevational view of the mounting structure illustrated in FIG. 9.

### DESCRIPTION OF THE INVENTION

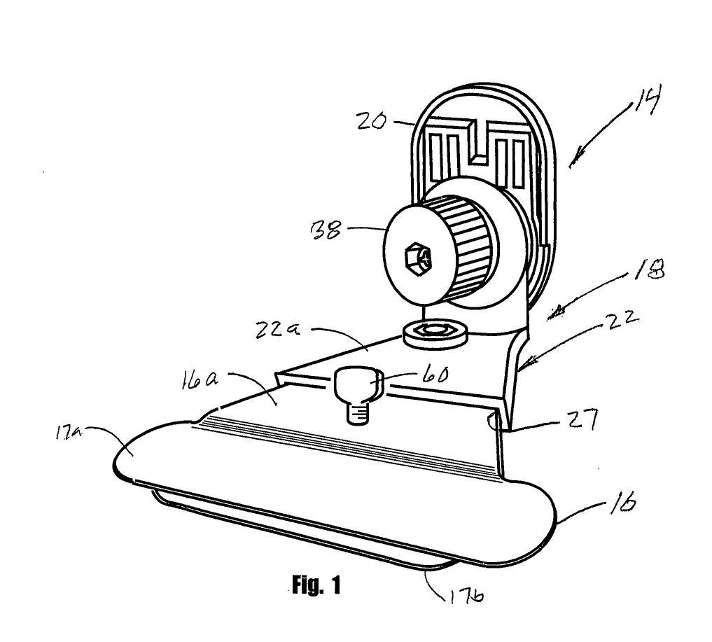

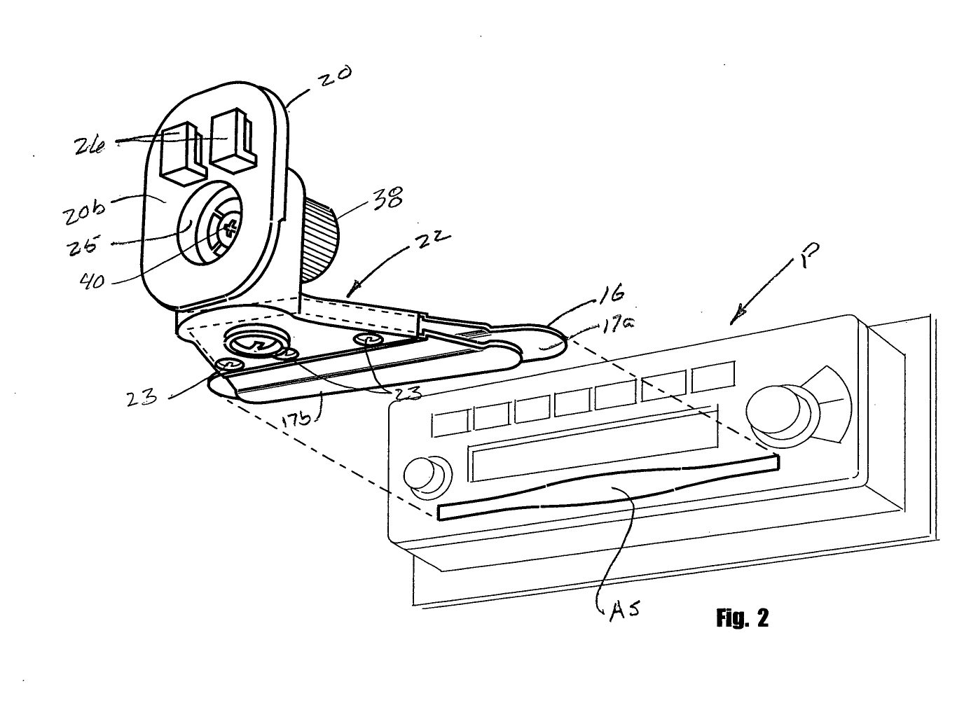

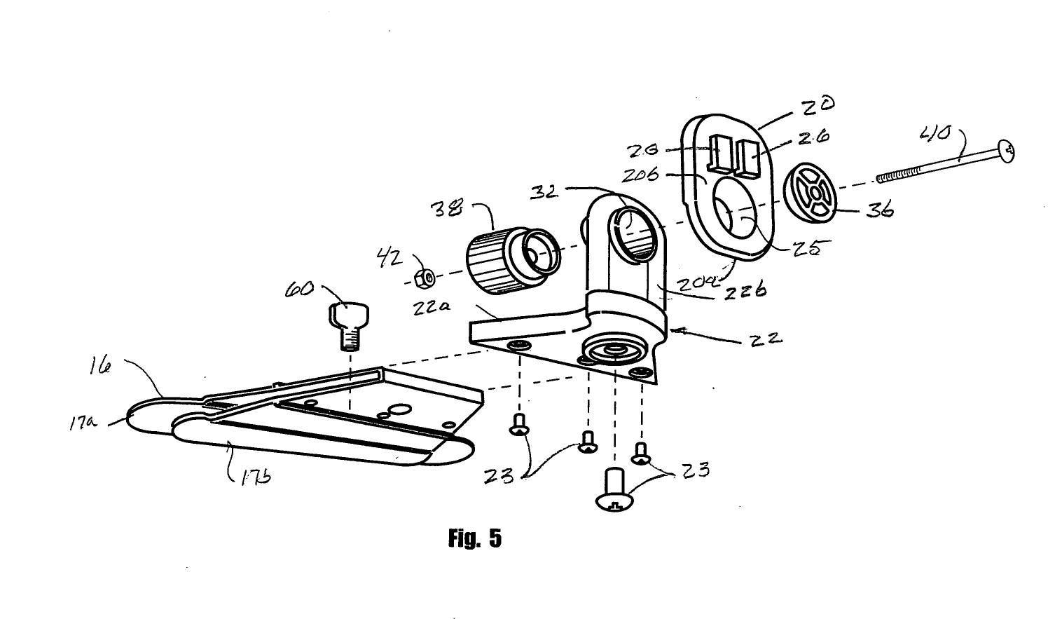

Referring to the drawings and particularly to FIGS. 1 through 5, one form of the mounting structure of the present invention is there illustrated and generally designated by the numeral 14. Mounting structure 14 is specially designed for supporting an object within a vehicle having a compact disk player “P” that includes a compact disk drive having an access slot “AS” (FIG. 2). As best seen in FIGS. 1 and 5 mounting structure 14 here comprises a connector tongue 16 that is removably receivable within the compact disk drive access slot “AS” in the manner indicated in FIG. 2 and a mounting assembly 18 that is connected to connector tongue 16. The important mounting assembly 18 here comprises a specially configured mounting plate 20 and a novel adapter assembly 22 that is disposed between mounting plate 20 and connector tongue 16. As best seen in FIGS. 4A and 5, adapter assembly 22 is connected to connector tongue 16 by a plurality of threaded connectors 23.

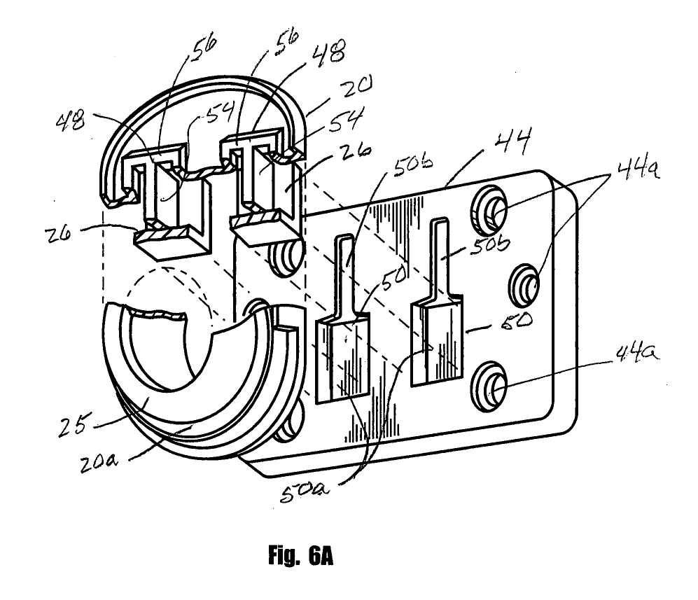

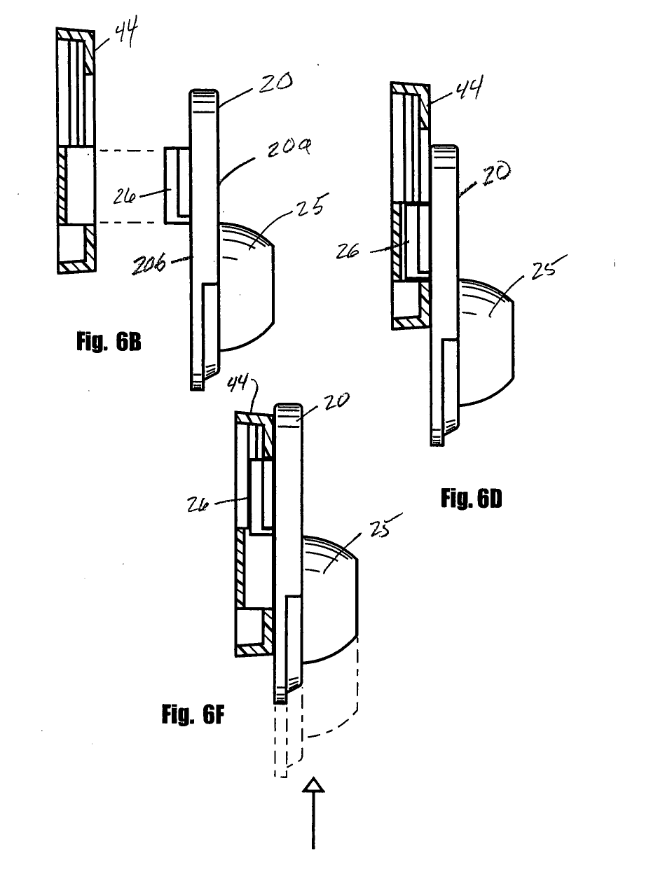

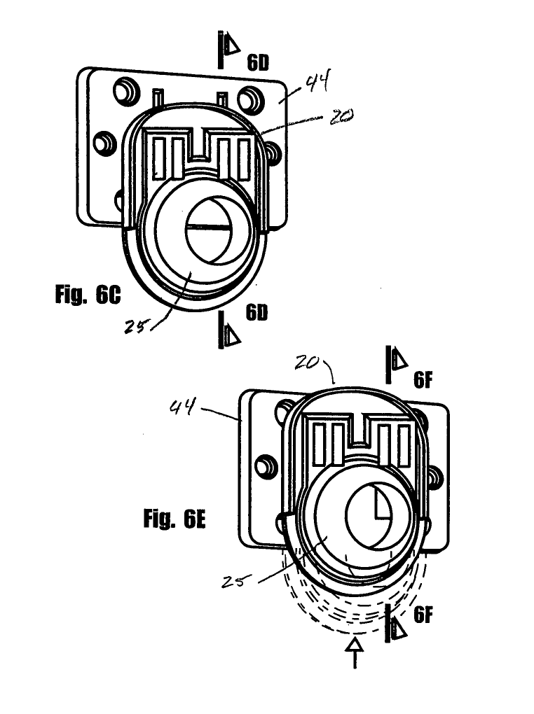

As shown in FIGS. 5 and 6A, mounting plate 20 has first and second surfaces 20a and 20b. Protruding from first surface 20a is generally hemispherically shaped portion 25 and protruding from second, generally planar surface 20b is a pair of transversely spaced-apart connector elements 26 the purpose of which will presently be described.

Adapter assembly 22 comprises a connector portion 22a and an upstanding portion 22b (FIGS. 1 and 5). Connector portion 22a includes a slot 27 within which the connector portion 16a of the connector tongue 16 is received (see FIG. 1).

As illustrated in FIG. 5 of the drawings, the upstanding portion 22b of the adapter assembly is provided with a socket portion 32 within which the generally hemispherically shaped ball portion 25 of the mounting plate 20 is rotatably received. Also forming a part of the adapter assembly 22 is locking means for preventing rotation of said generally hemispherically shaped ball portion within said socket. In the present embodiment of the invention this important locking means comprises a generally hemispherical-shaped spacer 36, which is receivable within the cavity formed by a generally hemispherically shaped portion 25. Spacer 36 is interconnected with a tightening knob 38, which also forms a part of the adapter assembly 22 by means of a screw 40 and a mating nut 42, which is held captive by tightening knob 38. Tightening knob 38, screw 40 and mating nut 42 also form a part of the locking means of the invention. With the novel construction thus described, by loosening knob 38, mounting plate 20 can be controllably swiveled in a manner to position the mounting plate within a plane that permits optimum viewing and operation of the article that is to be interconnected with the mounting plate in the manner next to be described.

An important feature of the mounting structure of the present invention is the provision of an article connector plate 44 (FIG. 6A) that can be interconnected with mounting plate 20 and to which the object that is to be carried by the mounting structure is connected. As previously mentioned and as illustrated in FIGS. 6A, 6B, 6C, 6D, 6E and 6F, mounting plate 20 is provided with a pair of uniquely configured, spaced-apart connector elements 26. As shown in FIG. 6A, each of the connector elements 26 is provided with an upstanding, generally “T”-shaped connector 48. “T”-shaped connectors 48 are lockably received within spaced-apart cavities 50 formed in the article connector plate 44. Plate 44, which is illustrated in FIG. 6A, is provided with a plurality of spaced-apart apertures 44a to permit the connector plate to be interconnected with various types of cradles (not shown) for supporting articles such as, for example, cell phones, PDA's, GPS devices and the like.

During the step of interconnecting the article connector plate 44 with the mounting plate 20, the connector plate is first moved from the position shown in FIGS. 6A and 6B into the position shown in FIG. 6D wherein the connector elements 26 of the mounting plate are moved into the larger portions 50a the cavities 50 of the article connector plate. This done, the mounting plate is moved from the configuration shown in the dotted lines in FIGS. 6E and 6F into the position shown by the solid lines in FIGS. 6E and 6F. During this movement, the leg portions 54 of the “T”-shaped locking elements of the mounting plate (FIG. 6A) will slide into the elongated slot portions 50b of the cavities 50 formed in the connector plate 44 and will be securely locked in position by the top wall portions 56 of the connector elements 26. With this novel construction, the uniquely designed connector elements 26 of the connector plate are snugly received within the mating cavities of the object connector plate 44 so that play between the object connector plate in the mounting plate 20 is minimized. Additionally, the spaced-apart connector elements securely resist any rotational movement between the object connector plate and the mounting plate.

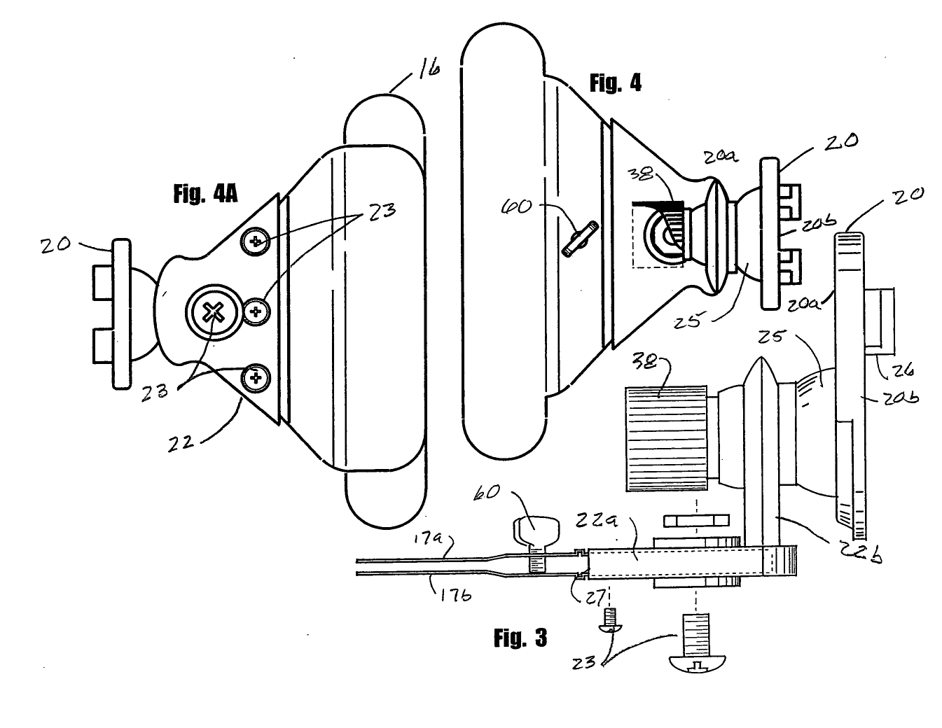

In using the apparatus of the invention, a finger engaging member, here shown as a thumb screw 60, is threadably connected to tongue 16 in a manner as seen in FIG. 3 of the drawings. Top and bottom walls 17a and 17b respectively are constructed and arranged so that the walls are continuously biased toward one another. With this construction, tightening of the thumb screw will tend to separate the top and bottom walls of the tongue, while loosening of the screw will permit the walls to move closer together. In their normal, at rest configuration, the spacing between the top and bottom walls will permit the tongue to be easily inserted into the CD access slot “AS”. Once the tongue is in position within the CD access slot, tightening of the thumb screw will cause the walls to move apart in a manner to securely position the tongue within the CD access slot “AS”.

With the tongue securely positioned within the CD access slot, the object to be displayed (not shown) is connected to the object connector plate 44 by means of connectors that are receivable within the apertures 44a formed in the object connector plate. By way of example, the object to be displayed may be a GPS device, or alternatively may be a cell phone. In this latter case, a cradle to support the cell phone (not shown) may be connected to the object connector plate. The combination of the object to be displayed and the object connector plate is then interconnected with the mounting plate 20 in a manner illustrated in FIGS. 6A through 6E. This done, tightening knob 38 is loosened so that the mounting plate 20 along with hemispherical member 36 can be swiveled into the desired plane to enable optimum viewing of the object be displayed.

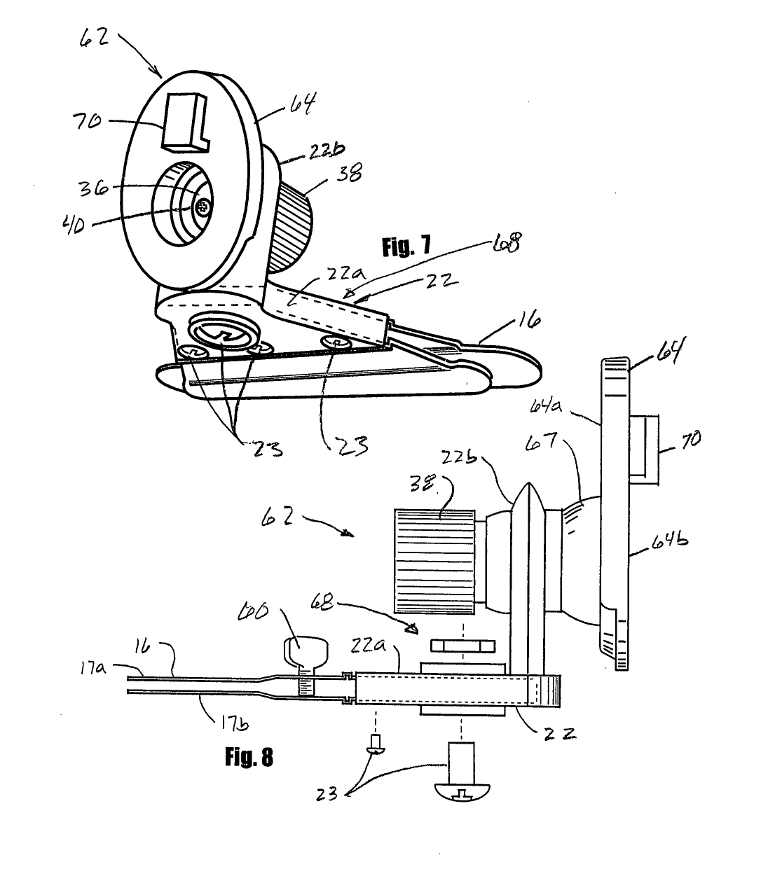

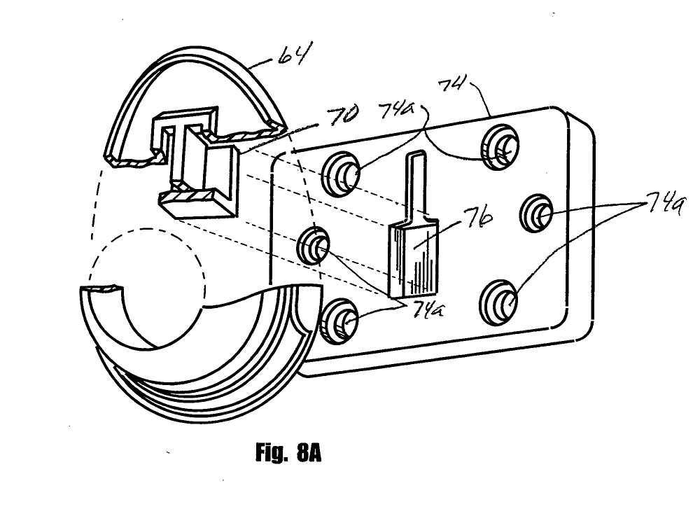

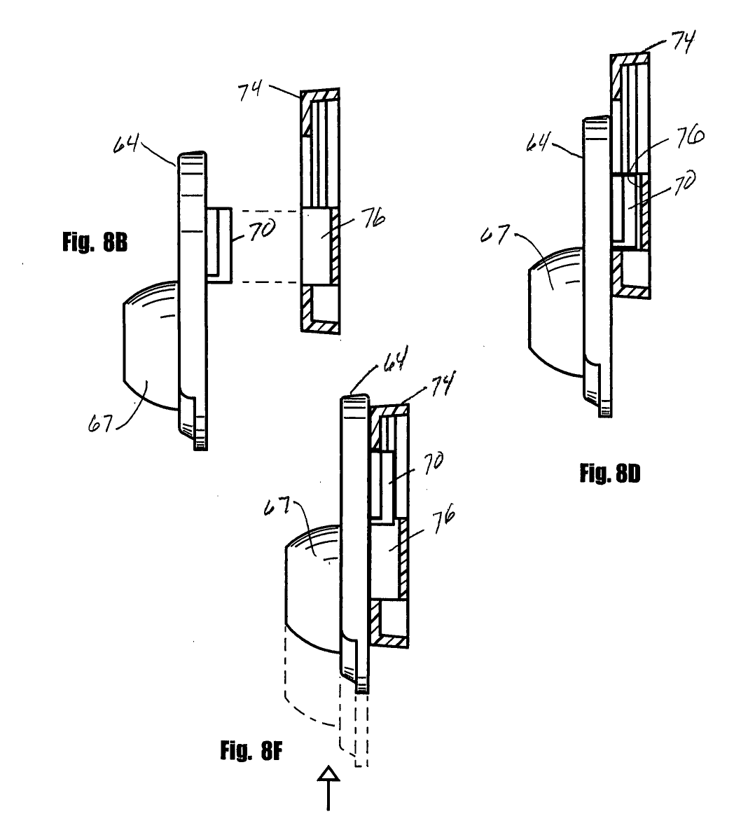

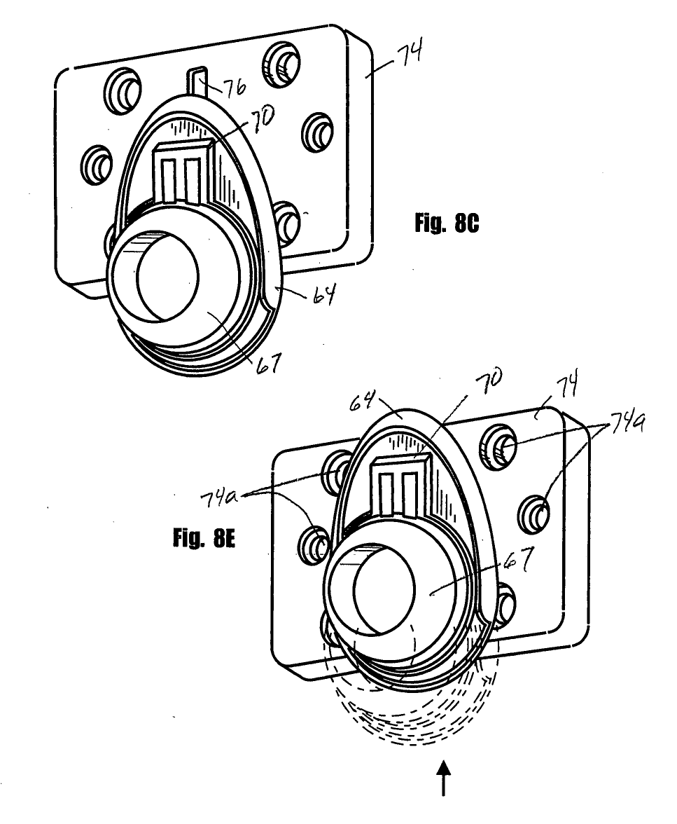

Turning next to FIGS. 7 and 8, an alternate form of the mounting structure of the invention is there shown and generally designated by the numeral 62. This alternate form of the invention is similar in many respects to that shown in FIGS. 1 through 6 and like numerals are used in FIG. 7 through 8 to identify like components. The primary difference between this alternate form of the invention and that previously described resides in the differently configured mounting plate. More particularly the mounting plate 64 is here provided with a single connector element rather than dual connector elements as in the earlier described embodiment. Referring particularly to FIG. 7 of the drawings, mounting structure 62 can be seen to comprise a connector tongue 16 that is identical in construction and operation to that previously described. As before, connector tongue 16 is removably receivable within the compact disk drive access slot “AS” in the manner previously described and as indicated in FIG. 2 and a mounting assembly 68 is connected to connector tongue 16. Mounting assembly 68 here comprises the previously identified mounting plate 64 and a novel adapter assembly 22 that is substantially identical in construction and operation to that previously described and, as before, is disposed between mounting plate 64 and connector tongue 16.

As shown in FIG. 8, mounting plate 64 has first and second surfaces 64a and 64b. Protruding from first surface 64a is generally hemispherically shaped portion 67 and protruding from second, generally planar surface 64b is a single connector element 70 that is of a similar configuration to connector elements 26 of the previously described embodiment.

As in the earlier described embodiment of the invention, upstanding portion 22b of the adapter assembly is provided with a socket portion 32 within which the generally hemispherically shaped ball portion 67 of the mounting plate 64 is rotatably received. Also forming a part of the adapter assembly 22 is the generally hemispherical-shaped spacer 36, which is receivable within the cavity formed by a generally hemispherically shaped portion 67. Spacer 36 is interconnected with a tightening knob 38, which also forms a part of the adapter assembly 22 by means of a screw 40 and a mating nut 42, which is held captive by tightening knob 38. With this construction, by loosening knob 38, mounting, plate 64 can be controllably swiveled in the manner previously described to position the mounting plate 64 within a plane that permits optimum viewing and operation of the article that is to be interconnected with the mounting plate.

Also forming a part of the mounting structure of this alternate form of the invention is an article connector plate 74 (FIG. 8A) that is somewhat similar in construction to connector plate 44. Article connector plate 74 can be interconnected with mounting plate 64 in the manner illustrated in FIGS. 8A through 8F. As in the earlier described embodiment of the invention, the object that is to be carried by the mounting structure is connected by means of suitable connectors to the article connector plate.

As shown in FIG. 7, connector element 70, which is generally “T”-shaped in configuration, is lockably received within a specially configured cavity 76 formed in the article connector plate 74. Plate 74, which as illustrated in FIG. 8A, is provided with a plurality of spaced-apart apertures 74a to permit the connector plate to be interconnected by means of suitable connectors (not shown) with various types of cradles (not shown) for supporting articles such as, for example, cell phones, PDA's, GPS devices and the like.

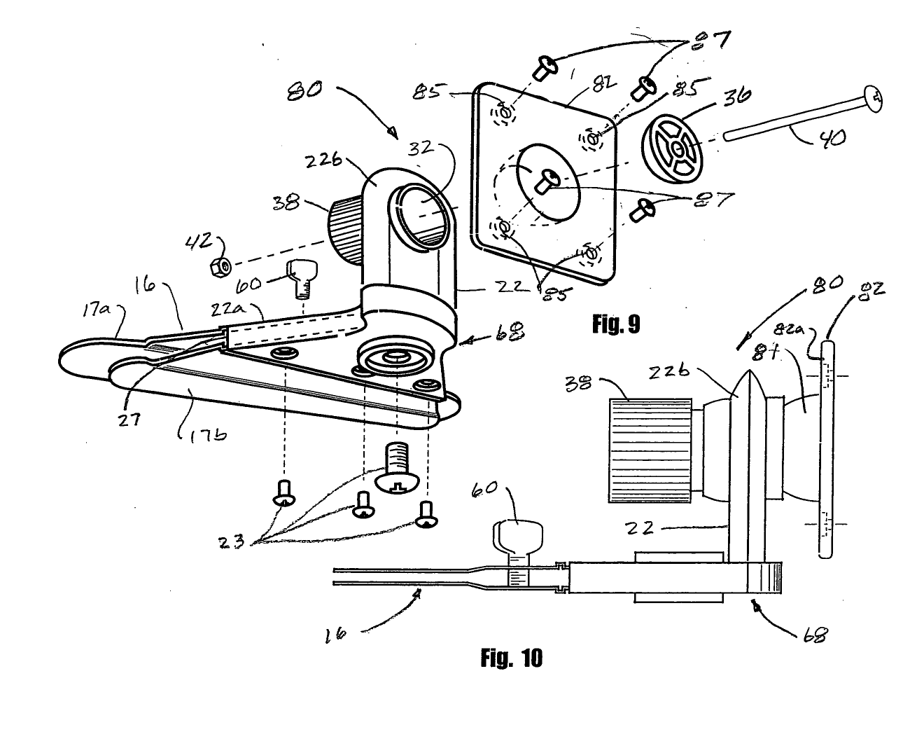

Turning next to FIGS. 9 and 10, still another form of the mounting structure of the invention is there shown and generally designated by the numeral 80. This latest form of the invention is also similar in many respects to that shown in FIGS. 1 through 6 and like numerals are used in FIGS. 9 and 10 to identify like components. The primary difference between this latest form of the invention and that previously described resides in the differently configured mounting plate 82, which here functions both as a mounting plate and as an article connector plate. More particularly, mounting plate 82 here includes a generally hemispherically shaped portion 81 that protrudes from a generally planar surface 82a.

As in the earlier described embodiments of the invention, mounting structure 80 comprises a connector tongue 16 that is identical in construction and operation to that previously described. As before, connector tongue 16 is removably receivable within the compact disk drive access slot “AS” in the manner previously described and as indicated in FIG. 2. A mounting assembly 68 which is substantially identical in construction and operation to that previously described is connected to connector tongue 16 in the manner shown in FIG. 10 of the drawings and comprises the previously identified mounting plate 82 and a novel adapter assembly 22 that is also substantially identical in construction and operation to that previously described.

As shown in FIG. 9, mounting plate 82 is provided with a plurality of spaced-apart bores 85 that are adapted to receive a plurality of connectors 87 that function to interconnect the combination mounting plate-connector plate 82 with various types of cradles (not shown) for supporting articles such as, for example, cell phones, PDA's, GPS devices and the like.

As in the earlier described embodiments of the invention, upstanding portion 22b of the adapter assembly is provided with a socket portion 32 within which the generally hemispherically shaped ball portion 81 of the mounting plate 82 is rotatably received. Also forming a part of the adapter assembly 22 is the generally hemispherical-shaped spacer 36, which is receivable within the cavity formed by a generally hemispherically shaped portion 81. Spacer 36 is interconnected with a tightening knob 38, which also forms a part of the adapter assembly 22 by means of a screw 40 and a mating nut 42, which is held captive by tightening knob 38. With this construction, by loosening knob 38, mounting plate 82 can be controllably swiveled in the manner previously described to position the mounting plate 82 within a plane that permits optimum viewing and operation of the article that is to be carried by the mounting plate.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A mounting structure for supporting an object within a vehicle having a compact disk player including a compact disk drive access slot, said mounting structure comprising:
(a) a connector tongue receivable within the compact disk drive access slot; and
(b) a mounting assembly connected to said connector tongue, said mounting assembly comprising:
(i) a mounting plate; and
(ii) a connector element connected to said mounting plate. being interconnected with said connector plate.

2. The mounting structure as defined in claim 1 further including an object connector plate interconnected with said connector element.

3. The mounting structure as defined in claim 2 in which said mounting plate has first and second surfaces and in which said connector element protrudes outwardly from said second surface.

4. The mounting structure as defined in claim 3 in which said object connector plate includes a cavity and in which said connector element comprise a generally “T”-shaped connector that is lockably received within said cavity formed in said object connector plate.

5. The mounting assembly as defined in claim 3, further including an adapter assembly disposed intermediate said a connector tongue and said mounting plate.

6. The mounting assembly as defined in claim 5 in which said first surface of said mounting plate includes a generally hemispherically shaped portion that defines an internal cavity and in which said adapter assembly includes a socket portion within which said generally hemispherically shaped ball portion is rotatably received.

7. The mounting assembly as defined in claim 6 in which said adapter assembly further includes locking means for preventing rotation of said generally hemispherically shaped ball portion within said socket.

8. The mounting assembly as defined in claim 7 in which said locking means comprises a generally hemispherical-shaped spacer, which is receivable within said internal cavity formed by a generally hemispherically shaped portion.

9. The mounting assembly as defined in claim 8 in which said locking means further comprises a tightening knob that is operably interconnected with said generally hemispherical-shaped spacer by a screw and a mating nut.

10. A mounting structure for supporting an object within a vehicle having a compact disk player including a compact disk drive access slot, said mounting structure comprising:
(a) a connector tongue receivable within the compact disk drive access slot;
(b) an adapter assembly connected to said connector tongue;
(c) a mounting plate connected to said adapter assembly;
(d) a pair of connector elements connected to said mounting; and
(e) a connector plate connected to said connector element, the object being interconnected with said connector plate.

11. The mounting structure as defined in claim 10 in which said mounting plate has first and second surfaces and in which said pair of connector elements protrude outwardly from said second surface.

12. The mounting structure as defined in claim 11 in which said object connector plate includes a pair of spaced-apart cavities and in which said connector elements comprise generally “T”-shaped connectors that are received within said cavities formed in said object connector plate.

13. The mounting structure as defined in claim 11 in which said first surface of said mounting plate includes an outwardly extending, generally hemispherically shaped portion that defines an internal cavity.

14. The mounting assembly as defined in claim 13 in which said adapter assembly includes a socket portion within which said generally hemispherically shaped ball portion is rotatably received.

15. The mounting assembly as defined in claim 14 in which said adapter assembly further includes locking means for preventing rotation of said generally hemispherically shaped ball portion within said socket.

16. The mounting assembly as defined in claim 15 in which said connector tongue includes top and bottom walls that are constructed and arranged so that said top and bottom walls are continuously biased toward one another.

17. The mounting assembly as defined in claim 16 further including a finger engaging member carried by said top wall of said connector tongue for separating said top and bottom walls of said connector tongue.

18. A mounting structure for supporting an object within a vehicle having a compact disk player including a compact disk drive access slot, said mounting structure comprising:
(a) a connector tongue receivable within the compact disk drive access slot, said connector tongue having top and bottom walls that are constructed and arranged so as to be continuously biased toward one another;
(b) a finger engaging member carried by said top wall of said connector tongue for controllably separating said top and bottom walls of said connector tongue;
(c) an adapter assembly connected to said connector tongue, said adapter assembly comprising a connector portion and an upstanding portion, said upstanding portion having a socket portion;
(d) a mounting plate connected to said upstanding portion of said adapter assembly, said mounting plate having first and second surfaces, and including an outwardly extending, generally hemispherically shaped portion extending from said first surface that defines an internal cavity and a pair of connector elements carried by said second surface, said generally hemispherically shaped portion of said mounting plate being rotatably received within said socket portion of said upstanding portion of said adapter assembly; and
(e) a connector plate connected to said connector element, the object being interconnected with said connector plate.

19. The mounting structure as defined in claim 18 in which said object connector plate includes a pair of spaced-apart cavities and in which said connector elements comprise generally “T”-shaped connectors that are received within said cavities formed in said object connector plate.

20. The mounting assembly as defined in claim 19 in which said adapter assembly further includes locking means for preventing rotation of said generally hemispherically shaped ball portion of said mounting plate within said socket.
